(19) United States
(12) Patent Application Publication
(10) Pub. No.: US 2004/0245808 A1
(43) Pub. Date: Dec. 9, 2004

(54) Method and apparatus for attaching a sunroof panel after installation

(76) Inventor: John E. Long, Highland, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/457,618

(22) Filed: Jun. 9, 2003

(51) Int. Cl. B60J 7/043

(52) U.S. Cl. 296/216.07

(57) ABSTRACT

A three-part fastener is utilized to attach a sunroof panel to a moving frame in a sunroof assembly. The three-part fastener includes a threaded bolt received in an intermediate nut which is in turn received in an outer nut. By turning the threaded bolt from a position outside of the vehicle, the intermediate nut moves within the outer nut to secure the sunroof panel at a final position. The use of this fastener allows final adjustment of the location of the sunroof panel from a location outwardly of the vehicle, and thus does not require assembly line workers to move into the vehicle cab.

### BACKGROUND OF THE INVENTION

This application relates to a method and apparatus for attaching the panel of a sunroof to the vehicle, and providing final adjustment from outside of the vehicle cab.

Modem vehicles are often provided with a sunroof assembly. As is known, a sunroof assembly includes both a fixed frame, a motor, drive structure, a movable frame, and a panel supported by the movable frame and typically formed of a transparent material such as glass. The sunroof panel is movable between an open position at which it allows air to flow through an opening in a vehicle roof, and to a closed position at which it blocks air flow.

Typically, the sunroof assembly is assembled into the vehicle as a unit. The sunroof assembly fixed frame, motor, drive structure, movable frame, and sunroof panel are moved as a single unit into the vehicle and mounted to an inner surface of the roof frame. At some time thereafter, the sunroof panel must be adjusted to a final position relative to the roof. In the prior art, typically, the sunroof assembly has been mounted into the vehicle through a robotic assembly element. An assembly line worker then needed to enter the vehicle cab and tighten appropriate screws, etc. to move the sunroof panel to its final position.

It is a desire of modem vehicle assembly lines to minimize assembly line workers entering the cab vehicle. The assembly line workers may carry dirt, grease, etc. and stain the interior of the vehicle. Further, it is also desirable to minimize assembly line workers needing to move into any restricted area such as the partially assembled vehicle cab.

Three-part threaded fasteners having a bolt driving an intermediate nut which is in turn within an outer nut have been utilized in vehicles to attach roof panels to the frame of a roof. However, these applications are for the opaque roof panels themselves and not for a moving element such as a sunroof panel.

For the reasons set forth above, it would be desirable to have an improved way of adjusting the final position of the sunroof panel in a sunroof assembly.

### SUMMARY OF THE INVENTION

In an embodiment of this invention, a sunroof panel is attached to its moving frame through a three-part threaded fastener. The three-part fastener includes a bolt that is accessible outwardly of the vehicle. This bolt drives a threaded intermediate nut, which is threaded into an outer nut. As the bolt is turned, it drives the intermediate nut within the outer nut such that the intermediate nut moves to a final fixed position holding the sunroof panel at a desired position.

Since this bolt extends to an outer surface of the sunroof panel, it is adjusted by a worker outward of the vehicle cab. In further features, the bolt of the three-part fastener includes a cotter pin to prevent its removal from outside of the vehicle, providing additional anti-theft protection.

These and other features of the present invention can be best understood from the following specifications and drawings, the following of which is a brief description.

### BRIEF DESCRIPTION OF THE DRAWINGS

FIG. 1 schematically shows the movement of a sunroof assembly into the cab of a vehicle.

FIG. 2 is a highly schematic view of the attachment of the sunroof assembly to the roof frame of the vehicle.

FIG. 3 is a cross-sectional view of a first step in the final adjustment of the sunroof panel.

FIG. 4A shows a first final adjustment position.

FIG. 4B shows another final adjustment position.

### DETAILED DESCRIPTION OF THE PREFERRED EMBODIMENT

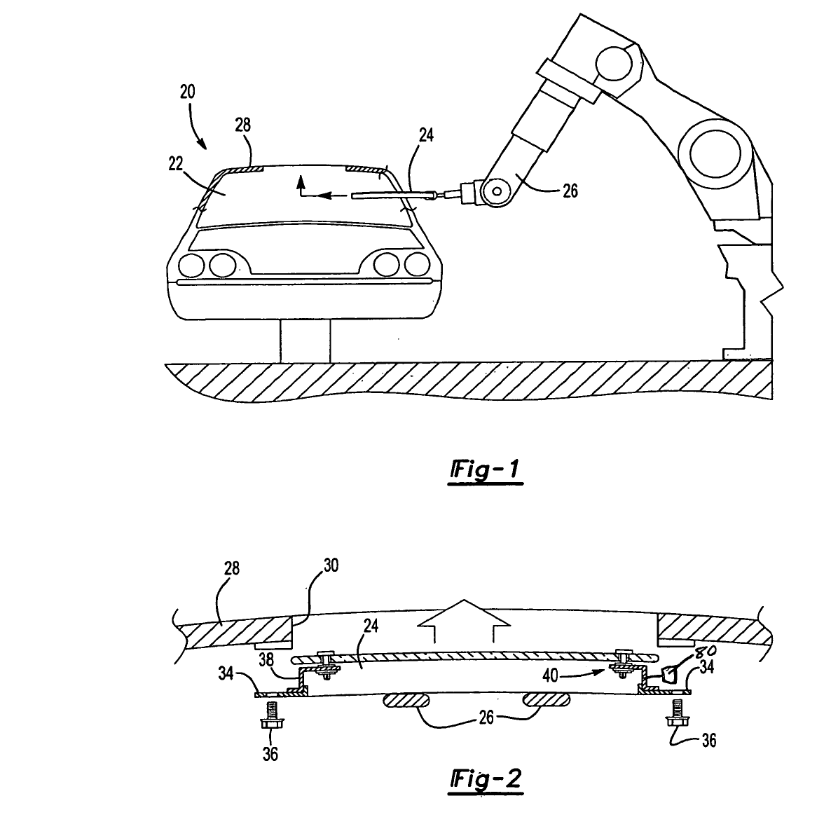

An assembly line 20 is illustrated in a highly schematic manner in FIG. 1. As shown, a vehicle frame 22 is receiving a sunroof assembly 24 through a robotic assembler 26. The sunroof assembly 24 is to be attached to the roof 28 of the vehicle frame 22.

As shown in FIG. 2, the roof 28 has an opening 30 which is to receive the sunroof assembly 24. The sunroof assembly 24 includes a sunroof panel 32. Further, there is a fixed frame 34 that receives bolts 36 to secure the sunroof assembly 24 to the roof 28. Bolts 36 are typically driven by structure on the robot 26. This attachment may be as known in the art, and thus is not illustrated in any detail in this application.

As also known, the fixed frame 34 supports a movable frame 38. The movable frame 38 and the sunroof panel 32 are driven by a motor (not shown) relative to fixed frame 34 as is known.

A threaded fastener 40 attaches a sunroof panel 32 to the movable frame 38. This allows adjustment of the final position of the sunroof panel 32 relative to the fixed frame 34, the roof 28, etc.

Notably, as shown in FIG. 3, an opening 42 in the glass panel 32 receives bolt 44. A seal 46 seals between the head of the bolt 44 and the sunroof panel 32. A cotter pin 48 extends through the bolt 44 to prevent its removal from a position outside of the vehicle. The fastener 40 is of a generally known type including an intermediate nut 50 and an outer nut 52. There is a threaded connection 54 between the intermediate and outer nuts 52 and 50, and a threaded connection between the bolt 44 and the intermediate nut 50. Bolt 44 may be made visually aesthetically pleasing.

As shown, a worker may drive the bolt 44 from a position outside the vehicle. As bolt 44 is driven, the position of the sunroof 32 is brought snug to the final position relative to the roof 28 and the fixed frame 34. The final position, and how it is defined is as known in the art, and thus, it is shown somewhat schematically in the figures in this application.

However, due to the three-part fastener 40, the bolt 44 can be driven from a position outside the vehicle. Thus, an assembly line worker need not enter the vehicle cab.

As can be appreciated from FIGS. 4A and 4B, as the bolt 44 is driven, the intermediate nut 50 moves within the outer nut 52. As shown in FIG. 4A, a head 58 of the intermediate nut 50 abuts an inner surface of the glass panel 32. As shown in FIG. 4B, the head is somewhat slightly spaced. Thus, as can be appreciated from FIGS. 4A and 4B, some ability to adjust the final position is provided by the three-part fastener. Even so, the three-part fastener still holds the glass panel securely against its final position in the roof 28.

In a method according to this invention, the sunroof assembly 24 is initially moved into the frame 22 of the vehicle and secured through the robotic assembler 26. A final adjustment of the position of the glass panel 32 may then be made by an assembly line worker outward of the vehicle by tightening the bolts 44.

Although preferred embodiments of this invention have been disclosed, a worker of ordinary skill in the art would recognize that certain modifications would come within the scope of this invention. For that reason, the following claims should be studied to determine the true scope and content of this invention.

1. A sunroof assembly comprising:
a fixed frame structure attachable to a frame of a vehicle;
a moving frame structure movable relative to said fixed frame structure, and a motor to drive said moving frame structure relative to said fixed frame structure; and
a sunroof panel attached to move with said moving frame structure, said sunroof panel being attached to said moving frame structure by a threaded fastener which is adjustable from an outer face of said sunroof panel opposed to a face of said sunroof panel which faces said moving frame.

2. The sunroof assembly as set forth in claim 1, wherein said threaded fastener includes a threaded bolt atop said outer face of said sunroof panel and extending through a hole in said sunroof panel to be received in an intermediate nut, said intermediate nut being received in an outer nut, said outer nut being received in said moving frame structure such that said threaded bolt may be driven to drive said intermediate nut within said outer nut and secure and adjust said sunroof panel relative to said moving frame structure.

3. The sunroof assembly as set forth in claim 2, wherein a cotter pin extends through an end of said threaded bolt beyond said intermediate nut.

4. A vehicle comprising:
a vehicle roof frame;
a fixed frame structure attached to said roof frame;
a moving frame structure for moving relative to said fixed frame structure, and a motor to drive said moving frame structure relative to said fixed frame structure; and
a sunroof panel attached to move with said moving frame structure, said sunroof panel being attached to said moving frame structure by a threaded fastener which is adjustable from outside said vehicle roof frame.

5. The vehicle assembly as set forth in claim 4, wherein said threaded fastener includes a threaded bolt atop an outer face of said sunroof panel and extending through a hole in said sunroof panel to be received in an intermediate nut, said intermediate nut being received in an outer nut, said outer nut being received in said moving frame structure such that said threaded bolt may be driven to drive said intermediate nut within said outer nut and secure and adjust said sunroof panel relative to said moving frame structure.

6. The vehicle assembly as set forth in claim 5, wherein a cotter pin extends through an end of said threaded bolt beyond said intermediate nut.

7. A method of attaching a sunroof to a vehicle comprising the steps of:
(1) providing a sunroof assembly including a fixed frame structure, a moving frame structure, and a panel attached to said moving frame structure;
(2) mounting said sunroof assembly by moving said sunroof assembly into an interior of a vehicle frame and attaching said fixed frame structure to a roof of said vehicle frame; and
(3) finally adjusting the final position of said panel relative to said roof frame by driving a threaded member from a location outward of said vehicle frame.

8. The method as set forth in claim 7, wherein the step (3) occurs after step (2).

9. The method as set forth in claim 7, wherein a motor is attached to drive said moving frame structure relative to said fixed frame structure.
